(19) United States
(12) Patent Application Publication
(10) Pub. No.: US 2013/0293444 A1
(43) Pub. Date: Nov. 7, 2013

(54) MOBILE TERMINAL

(71) Applicant: Sony Mobile Communications AB, Lund (SE)

(72) Inventors: Tatsuya SANO, Tokyo (JP); Naka SHIBATA, Lund (SE)

(21) Appl. No.: 13/873,845

(22) Filed: Apr. 30, 2013

Related U.S. Application Data
(60) Provisional application No. 61/641,327, filed on May 2, 2012.

(51) Int. Cl. G06F 3/14

(52) U.S. Cl. CPC G06F 3/1446
USPC 345/1.3

(57) ABSTRACT

An information processing apparatus including a first case including a first display unit having a first display screen; and a second case including a second display unit having a second display screen. The first and second cases are rotatably linked by a hinge so that both of the first and second display screens are exposed to an outside in a closed state and both the first and second display screens are adjacently placed on substantially same plane in an open state. The information processing apparatus also includes a detector that detects whether the first and second cases are in the open state or the closed state. Based on an output of the detector selected functions of the first and second display units may be enabled or disabled.

### CROSS REFERENCE TO RELATED APPLICATION

The present application claims the benefit of the earlier filing date of U.S. Provisional Patent Application Ser. No. 61/641,327 filed on May 2, 2012, the entire contents of which is incorporated herein by reference.

### BACKGROUND

1. Field of the Disclosure

The present disclosure relates to a mobile terminal with a first case and a second case linked with a hinge part.

2. Description of Related Art

Mobile terminals called smart phones have rapidly come into widespread use. These mobile terminals are equipped with a display unit that has a display screen with a touch detection function. A user can enter various commands and information item into the mobile terminal by touching the display screen.

The structure of this type of mobile terminal enables a numeric keypad, which is a hardware component, to be eliminated. Thus, even a so-called straight-type of mobile terminal can have a display screen with a relatively large size.

A mobile terminal like a game machine has been proposed that has a display screen on the front side of the case and also has touch sensors on the rear side. There is no significant difference in size between this display screen and a straight-type of mobile terminal.

By contrast, mobile terminals, called tablet terminals or tablet-type terminals, that have a larger display screen with a touch detection function than smart phones are also commercially available.

### SUMMARY

However, the tablet terminal has to use a large case to accommodate a display device having a large-size display screen, so the tablet terminal is inferior in portability to the smart phone.

Regarding this problem, a terminal model with a foldable two-screen body has been proposed as a structure that satisfies two requirements, portability and a large display screen, simultaneously. This terminal model can be used not only in a smart phone style in which the terminal model in a folded state (closed state) but also in a large-screen tablet style in which the terminal model is in an open state.

To use a foldable mobile terminal formed with a first case and a second case as a tablet terminal, the display screens of the two cases must be placed side by side so as to be flush with the two cases open 180 degrees. If a conventional hinge is used, therefore, a form in which a hinge part protrudes from one edge of the terminal has to be used. A resulting convex part on the hinge part impairs the external appearance of the mobile terminal in the closed state, lacking in designability.

In a mobile terminal with a first case and a second case linked with a hinge part, the inventors recognize the necessity to reduce unevenness between the two cases in the open state without using a form in which the hinge protrudes from one edge of the terminal in the closed state.

According to an embodiment of the present disclosure, a mobile terminal is provided that has a first case including a first display unit having a first display screen; and a second case including a second display unit having a second display screen. The first and second cases are rotatably linked by a hinge so that both of the first and second display screens are exposed to an outside in a closed state and both the first and second display screens are adjacently placed on substantially same plane in an open state. The information processing apparatus also includes a detector that detects whether the first and second cases are in the open state or the closed state. Based on an output of the detector selected functions of the first and second display units may be enabled or disabled.

### BRIEF DESCRIPTION OF DRAWINGS

FIGS. 1A and 1B are perspective views of the external appearance of a mobile terminal in an embodiment of the present disclosure in a closed state and an open state, respectively.

FIG. 2 is a side view of the mobile terminal in the open state, as viewed laterally.

FIG. 3A is a side view of a conventional foldable mobile terminal, and FIG. 3B is a cross sectional view schematically illustrating the structure of its hinge part.

FIG. 4A is a side view of a conventional foldable mobile terminal that uses a clamshell hinge, and FIG. 4B is a cross sectional view schematically illustrating the structure of its hinge part.

FIGS. 5A to 5E illustrate a more specific object to prevent the hinge part from extruding from one edge of the terminal in the closed state and to place its two display screens side by side on the same plane.

FIG. 6 is an exploded perspective view of the main parts of a hinge part in a first embodiment of the present disclosure.

FIG. 7 is a side view of the parts illustrated in FIG. 6 as viewed from a side.

FIGS. 8A and 8B are perspective views of the main parts of the hinge part in the open state as viewed from different directions.

FIG. 9 illustrates a location at which a hook-shaped end of a spring is secured.

FIGS. 10A to 10C illustrate a relationship, which determines the operation of the hinge part, between the ellipse protrusion of the arm member and a cam rail.

FIG. 11 illustrates a rotational angle obtained by the hinge part.

FIGS. 12A and 12B are perspective views of a mobile terminal in a second embodiment of the present disclosure in the closed state and open state, respectively.

FIGS. 13A and 13B are side views of the hinge part in the closed state and open state, respectively.

FIGS. 14A, 14B, and 14C illustrate a first arm assembly, a second arm assembly, and a combination of the two arm assemblies, respectively.

FIG. 15 is a perspective view of specific constituent components of the hinge part in the second embodiment.

FIG. 16 is a perspective view of a hinge part formed by combining the constituent components illustrated in FIG. 15 (excluding the first and second bases).

FIGS. 17A to 17E illustrate the states of the link mechanism of the hinge part, starting from the closed state of the mobile terminal in the second embodiment and continuing until the mobile terminal reaches the open state through a transient state.

FIG. 18 illustrates the effect of the second arm assembly in the open state.

FIGS. 19A and 19B are perspective views of a mobile terminal in a third embodiment of the present disclosure in the closed state and open state, respectively.

FIG. 20 is an exploded perspective view of a hinge part in the third embodiment of the present disclosure.

FIG. 21 is a side view of a plurality of constituent components of the hinge part in FIG. 20.

FIG. 22 is an enlarged view illustrating an example of the structure of the hinge part at the left end in FIG. 20.

FIG. 23 is an enlarged view illustrating an example of the structure of the hinge part at the right end in FIG. 20.

FIGS. 24A to 24C are side views of the third arm and fourth arm (second arm assembly) in the closed state, transient state, and open state in the third embodiment, respectively.

FIG. 25 is a side view of the first arm and second arm (first arm assembly) in the open state in the third embodiment.

FIGS. 26A to 26E illustrate the states of the link mechanism of the hinge part, starting from the closed state of the mobile terminal in the third embodiment and continuing until the mobile terminal reaches the open state through a transient state.

FIGS. 27A and 27B compare effects and advantages in the second embodiment and third embodiment.

FIGS. 28A and 28B compare the sizes of the hinges of the mobile terminals in the second embodiment and third embodiment in the closed state, as viewed from above.

FIGS. 29A and 29B compares the sizes of the hinges of the mobile terminals in the second embodiment and third embodiment in the closed state, as viewed from a side surface.

FIG. 30 is a block diagram illustrating an exemplary structure of the control hardware of the mobile terminal.

FIG. 31 is a flowchart illustrating exemplary processing, executed by a processing unit, that can be used for the mobile terminals in the embodiments.

### DETAILED DESCRIPTION

Embodiments of the present disclosure will be described in detail with reference to the drawings.

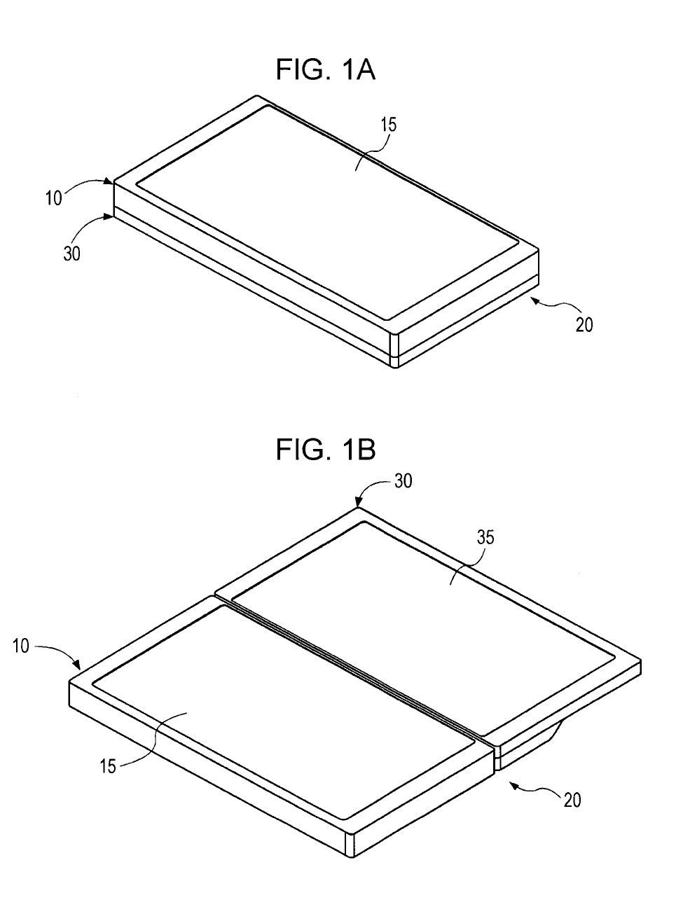

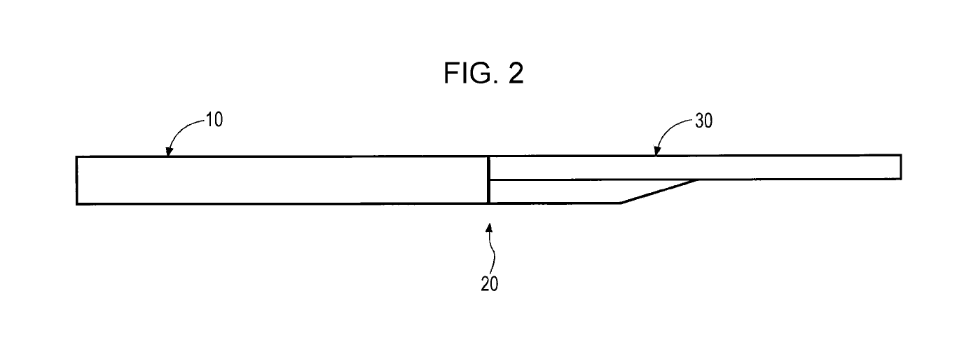

FIGS. 1A and 1B are perspective views of the external appearance of a mobile terminal in an embodiment of the present disclosure in a closed state and an open state, respectively. FIG. 2 is a side view of the mobile terminal in the open state, as viewed laterally.

The mobile terminal has a first case 10 equipped with a first display unit having a first display screen 15, a second case 30 equipped with a second display unit having a second display screen 35, and a hinge part 20 that rotatably links the two cases together between a closed state and an open state. The first display screen 15 and second display screen 35 have rectangular shapes that are substantially the same in size. As illustrated in FIG. 1A, both the first and second display screens are exposed to the outside (one of these screens is exposed upward and the other is exposed downward) in the closed state in which the first case 10 and second case 30 are overlaid.

As seen from FIG. 1B and FIG. 2, the hinge part 20 includes a mechanism that openably (rotatably) links the first case 10 and second case 30 together. In the open state, the display screens of the first and second display units are adjacently placed on substantially the same plane.

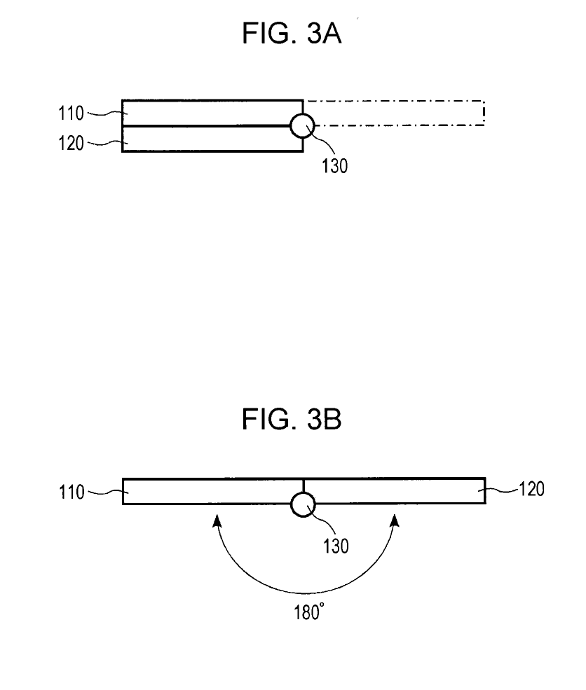

FIG. 3A is a side view of a conventional foldable mobile terminal, and FIG. 3B is a cross sectional view schematically illustrating the structure of its hinge part. As described above, the display screens of a case 110 and a case 120 are placed side by side on the same plane in the open state as if the display screens were a single large display screen, so in the structure of the conventional mobile terminal, a hinge part 130 protrudes from one end of the folded terminal in the closed state. In this embodiment, this problem is solved by using a structure described below in detail.

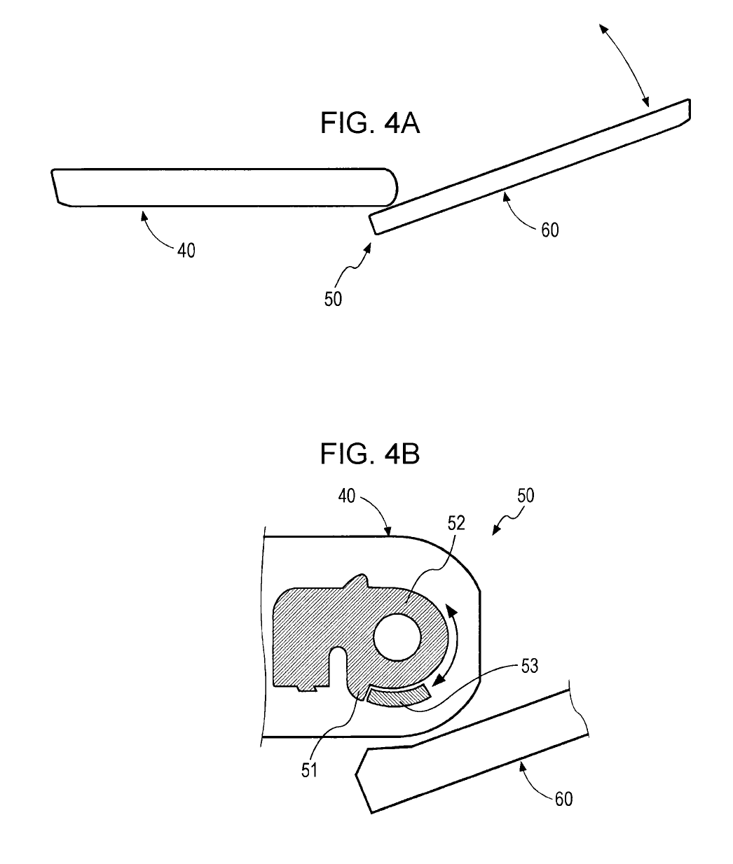

FIG. 4A is a side view of a conventional foldable mobile terminal that uses a clamshell hinge, and FIG. 4B is a cross sectional view schematically illustrating the structure of its hinge part 50. The so-called conventional clamshell hinge 50, which openably links an upper case 60 to a lower case 40, has a mechanism that prevents further rotation in the open state inside one end of one case (lower case 40 in this example). That is, a rotating piece 53, which rotates together with the other case (upper case 60 in this example) during opening and closing, is provided in a structural member 52 secured to the one case. In the open state, one end of the rotating piece 53 abuts a protrusion 51 formed on the structural member 52. When the upper case 60 is placed in the open state with respect to the lower case 40, therefore, the protrusion 51 functions as a rotation stopper that prevents further rotation in the open direction.

In this structure, the rotation stopper is present on a circumference with a relative small diameter, centered around the rotational axis of the clamshell hinge 50, so error in the rotational angle of the upper case 60 with respect to the lower case 40 in the open state becomes large. This error is further increased on the free end side of the upper case 60. The conventional foldable mobile terminal as illustrated in FIG. 4A does not require precision in the positioning of the upper case 60, so this error is not problematic. With the structure, as illustrated in FIG. 1B, in which the first case 10 and second case 30 open 180 degrees and is placed side by side on the same plane, however, the error is problematic. This is because this structure requires high precision in the positioning of the second case 30 with respect to the first case 10 in the open state. That is, there is a strict requirement for error in inclination and a step between the two cases.

Embodiments that solve this problem will be described below in detail.

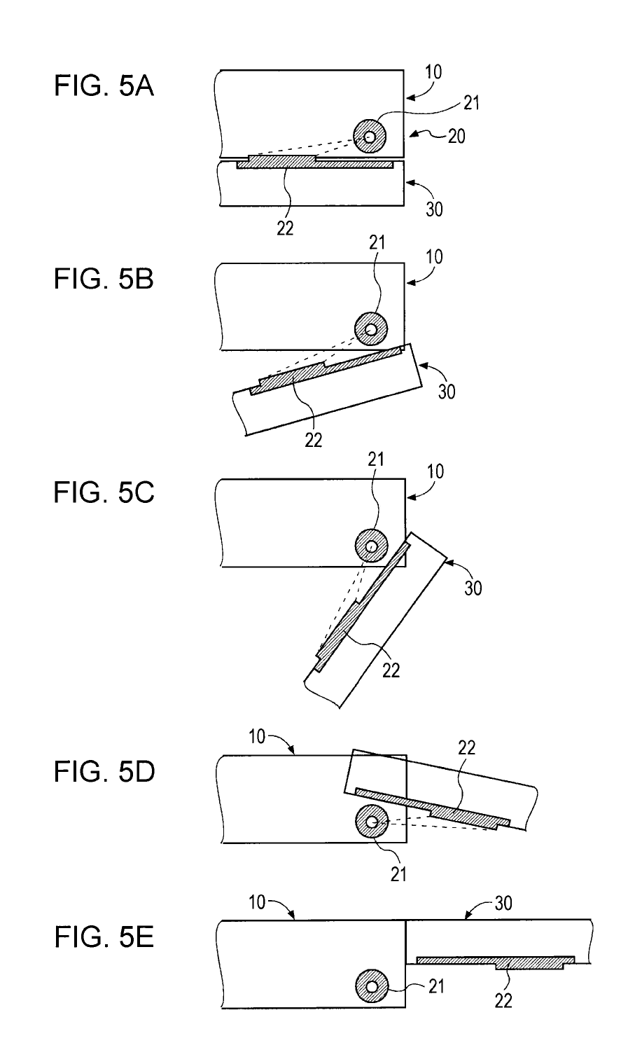

FIGS. 5A to 5E illustrate a more specific object to prevent the hinge part 20 from extruding from one edge of the terminal in the closed state and to place its two display screens side by side on the same plane by opening the first case 10 and second case 30 180 degrees. The hinge part 20 includes a rotating part 21 disposed in the first case 10 and a hinge base 22, which is a movable part rotating around the rotating part 21 by using it as a rotational axis. The hinge base 22 is secured to the second case 30.

To prevent the hinge part 20 from protruding from one edge of the terminal in the closed state, the rotating part 21 in the hinge part 20 needs to be disposed in a place relatively inside the first case 10.

As FIGS. 5A to 5D illustrate a progress of the rotation of the second case 30 from the closed state to the open state, the rotation trace of the case 30 interferes with the first case 10 during the rotation of the second case 30 around the rotating part 21 by using it as a rotational axis. This prevents the second case 30 from rotating with respect to the first case 10.

Accordingly, the terminal is desirably structured so that the hinge part 20 does not protrude from one end of the terminal in the closed state and the two cases do not mutually interfere when the second case 30 rotates with respect to the first case 10 around the rotating part 21 by using it as a rotational axis. In addition, as illustrated in FIG. 5E, the terminal is preferably structured so that in the open state obtained when the rotation is completed, the second case 30 reaches a position at which the display screens of the first case 10 and the second case 30 are adjacently placed on the same plane. An exemplary structure of the hinge part 20 that satisfies these requirements will be described below.

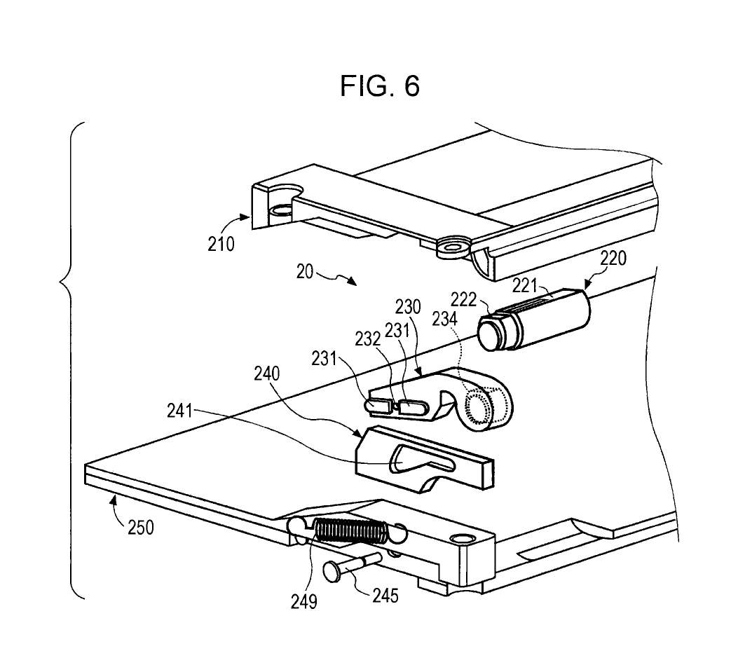

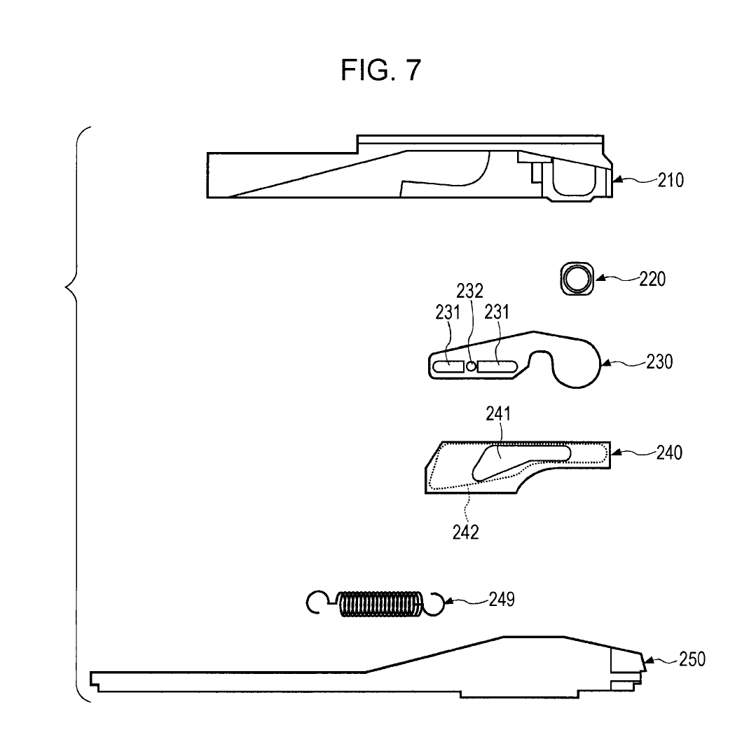

FIG. 6 is an exploded perspective view of the main parts of the hinge part 20 in a first embodiment of the present disclosure. Part of some parts is omitted. FIG. 7 is a side view of these main parts as viewed from a side.

The hinge part 20 includes a first base 210, cartridge hinges 220, arm members 230, cam rails 240, springs 249, and a second base 250. A set of parts including the cartridge hinge 220, arm member 230, cam rail 240, and spring 249 is disposed for each of the two sides in a direction along the rotational axis of the hinge part 20; a total of two sets are disposed. If the cartridge hinge 220 has a sufficient driving force, it may be disposed on only one side.

The first base 210 is a substantially plate-like member that extends across the entire width of the first case 10 in the longitudinal direction of the rotational axis of the hinge part 20. The first base 210 supports the cartridge hinge 220 and is secured to the first case 10 by fastening members such as screws. The second base 250 is a substantially plate-like member that extends across the entire width of the second case 30 in the longitudinal direction of the rotational axis of the hinge part 20. The second base 250 is secured to the second case 30 by fastening members such as screws. There is no particular restriction on the size (length) of the first base 210 and second base 250 in a direction orthogonal to the hinge axis. In this example, the length of the first base 210, which is relatively high, is small and the length of the second base 250, which is low, is long.

The cartridge hinge 220, which includes an elastic member (not shown) such as a coil spring, is a driving source that generates a driving force with which to open and close the two cases. This driving source generates a driving force with which both the open state and the closed state are maintained so that the open state is maintained when the first case 10 and second case 30 are in the open state and the closed state is maintained when the first case 10 and second case 30 are in the closed state. The main body 221 and rotating part 222 of the cartridge hinge 220 are placed side by side on the same axis. The rotating part 222 rotates with respect to the main body 221 in a prescribed rotational angle range (about 170 degrees in this example) between the closed state and the open state. The rotating part 222 receives a torque in a direction toward the closed state when the rotational angle is near the closed state and also receives a torque (inverted torque) in a direction toward the open state when the rotational angle is near the open state. As for the cartridge hinge 220 of this type, a known hinge used as a clamshell hinge can be used.

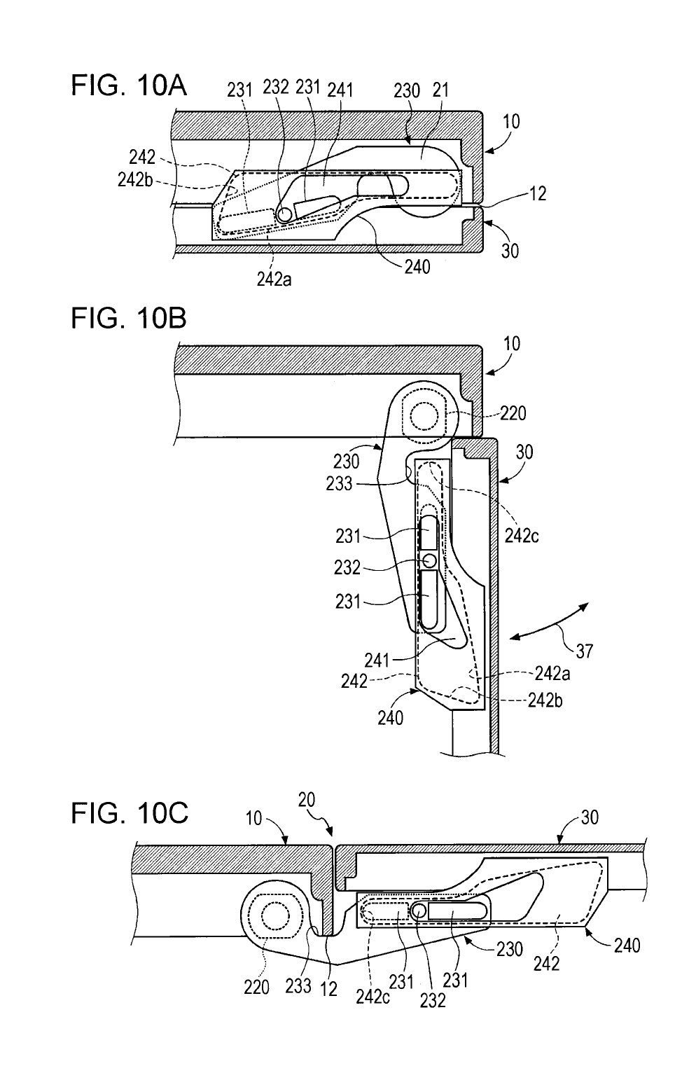

The arm member 230 is an elongated member, in an arm shape, that protrudes from a proximal end linked to the rotating part 222 to the outside of the first case 10 and is linked to the second case 30, as well illustrated in FIG. 10C described later. The arm member 230 has a function of transmitting a rotational force generated by the cartridge hinge 220 through the cam rail 240 to the second base 250. The arm member 230 has a hollow 234 at the proximal end, which is one end of the arm member 230, into which the rotating part 222 of the cartridge hinge 220 fits and is secured. The cross sections of the rotating part 222 and hollow 234 have a non-circular shape so that the rotating part 222 does not rotate freely in the hollow 234. Ellipse protrusions 231 extending substantially along the longitudinal direction of the arm member 230 are formed on the outward side surface at the other end. A hole 232, through which the arm member 230 is passed along the rotational axis, is formed at an intermediate position between the ellipse protrusions 231. The hole 232 supports a distal end of a pin 245 described later.

The cam rail 240 is secured to the second case 30 and functions as a follower driven by using the ellipse protrusions 231 of the arm member 230 as a driver. The ellipse protrusion 231 does not need to have an ellipse shape if its shape is such that a prescribed function of the driver in this embodiment is attained. For example, the ellipse protrusion 231 may be formed with a string (not shown) of a plurality of cylindrical protrusions.

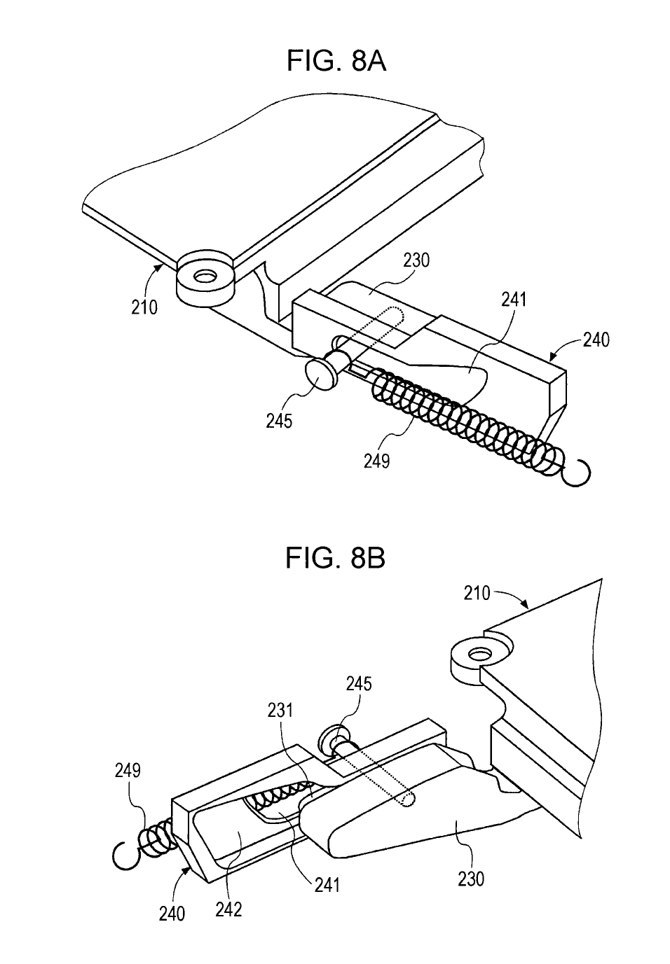

FIGS. 8A and 8B are perspective views of the main parts of the hinge part 20 in the open state as viewed from different directions.

A concave area 242 (FIG. 8B) is formed in the inner side of the cam rail 240; the ellipse protrusions 231 are accommodated in the concave area 242 so as to be movable in a prescribed range. A through-hole 241 is formed in part of the concave area 242. The pin 245 is externally passed through the through-hole 241 and its distal end is secured to the hole 232 in the arm member 230. The shape and size of the through-hole 241 are designed so that the pin 245 does not restrict the motion of the cam rail 240 (that is, the pin 245 does not come into contact with the cam rail 240).

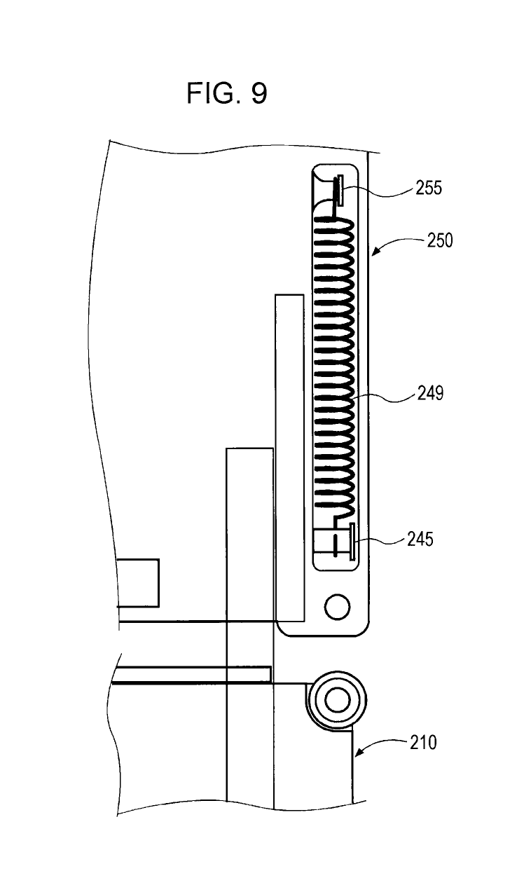

The spring 249, which is a type of elastic member, functions so as to draw the second case 30 toward the rotating part in the first case 10. The spring 249 is a coil spring that generates a tensile force when it is pulled; one hook-shaped end of the spring 249 is hooked on the pin 245. As illustrated in FIG. 9, the other hook-shaped end of the spring 249 is secured to a prescribed location 255 on the second base 250. The elastic member is not limited to a coil spring or a spring.

The operation of the hinge part 20 is determined as illustrated in FIGS. 10A to 10C. The relationship between the cam rail 240 and ellipse protrusions 231 of the arm member 230 will be described. FIGS. 10A to 10C are side views of the hinge part 20 in the closed, transient, and open states of the mobile terminal, respectively.

In the closed state illustrated in FIG. 10A, the ellipse protrusions 231 are positioned on an inclined part 242a on a wider side in the concave area 242 of the cam rail 240 in a state in which the ellipse protrusions 231 are inclined at a prescribed angle (about 10 degrees in this example) with respect to the main plane of the second case 30. When, in this state, the arm member 230 (pin 245) and second case 30 draw each other due to the elastic force of the spring 249, the distal end of the ellipse protrusion 231 abuts the inner wall 242b of the distal end on the wider side of the concave area 242. When the spring 249 is further pulled in this state (and against the elastic force of the cartridge hinge 220) and the second case 30 is rotated with respect to the first case 10 by using the rotating part 21 at the proximal end of the arm member 230 as a rotational axis, the transient state, in which the first case 10 and the second case 30 are substantially orthogonal to each other as illustrated in FIG. 10B, is reached. In this state, the second case 30 moves apart from the first case 10. Then, the ellipse protrusions 231 relatively move toward a narrower side in the concave area 242. As a result, the second case 30 rotates through a prescribed extra angle (about 10 degrees in this example) in the longitudinal direction of the ellipse protrusions 231.

When the second case 30 is further rotated from the state in FIG. 10B in the direction indicated by the arrow 37 while the second case 30 is being moved apart from the first case 10 against the tensile force of the spring 249, the open state illustrated in FIG. 10C is reached. In the course of reaching this open state, the ellipse protrusions 231 reach an end 242c on the narrower side of the concave area 242 while relatively sliding in the concave area 242. At that time, the display screen 35 of the second case 30 becomes substantially parallel in the longitudinal direction of the ellipse protrusions 231. Thus, the display screens of the first case 10 and second case 30 are placed side by side on the same plane so that their opposing outer surfaces of the first case 10 and second case 30 come into contact with each other, enabling the display screens to be seen as if they were a single display screen. This open state is stably maintained due to the effect of the spring 249 (and the spring built into the cartridge hinge 220) if no external force is exerted.

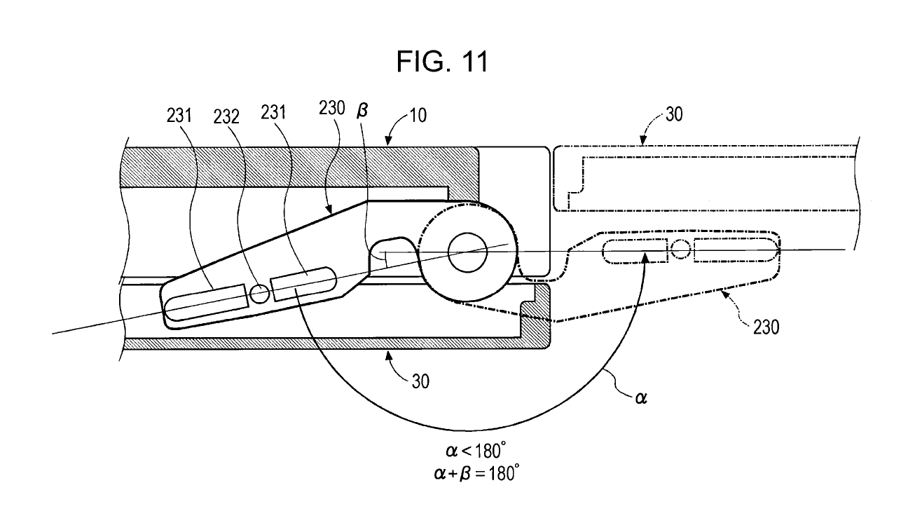

The rotational angle obtained by the hinge part 20 will be described with reference to FIG. 11. For convenience, the cam rail 240 is not shown in the drawing. When the mobile terminal shifts from the closed state to the open state, the arm member 230 itself rotates through only an angle smaller than 180 degrees (about 170 degrees in this example) due to a restriction on the function of the conventional cartridge hinge 220. However, the cam mechanism formed with the cam rail 240 and the ellipse protrusion 231 on the arm member 230 of the hinge part 20 provides an additional amount of rotation by a prescribed angle (about 10 degrees in this example). Therefore, the cam mechanism functions so as to hold the second case 30 so that it is movable relative to the arm member 230 within a prescribed area. More specifically, in the transient state during which the second case 30 shifts from the closed state to the open state with respect to the first case 10, the second case 30 shifts apart from the rotational part of the hinge part 20 against the elastic force of the spring 249. During this shift, the cam mechanism functions so as to rotate the second case 30 by a prescribed amount of rotation with respect to the arm member 230. As a result, when the second case 30 shifts from the closed state to the open state, the prescribed amount of rotation (about 10 degrees) is added by the cam mechanism to the maximum amount of rotation of the arm member 230, as part of the total amount of rotation of the second case 30 with respect to the first case 10.

This effect of the cam mechanism enables 180-degree rotation to be achieved by using the cartridge hinge 220, which rotates through only about 170 degrees.

Since, in the open state, part 233 of a side surface of the arm member 230 abuts an edge 12 of the first case 10, further rotation of the arm member 230 is prevented. In this structure, a rotation stopper is present on a circumference with a relative large diameter, centered around the rotational axis. Since the stopper is provided on a circumference with a relative large diameter in this way, error in the rotational angle of the second case 30 with respect to the first case 10 in the open state is lessened. Furthermore, since the second case 30 is drawn toward the first case with the springs in the open state, the clearance between the two cases is eliminated, reducing unevenness.

Next, a second embodiment of the present disclosure will be described.

The coil spring (tension spring) that has been used as the spring 249 in the first embodiment may adversely affect the antenna of a mobile terminal having a wireless communication function. To solve this problem, the second embodiment provides a hinge part 20a, the use of which enables the spring 249 in the first embodiment to be eliminated.

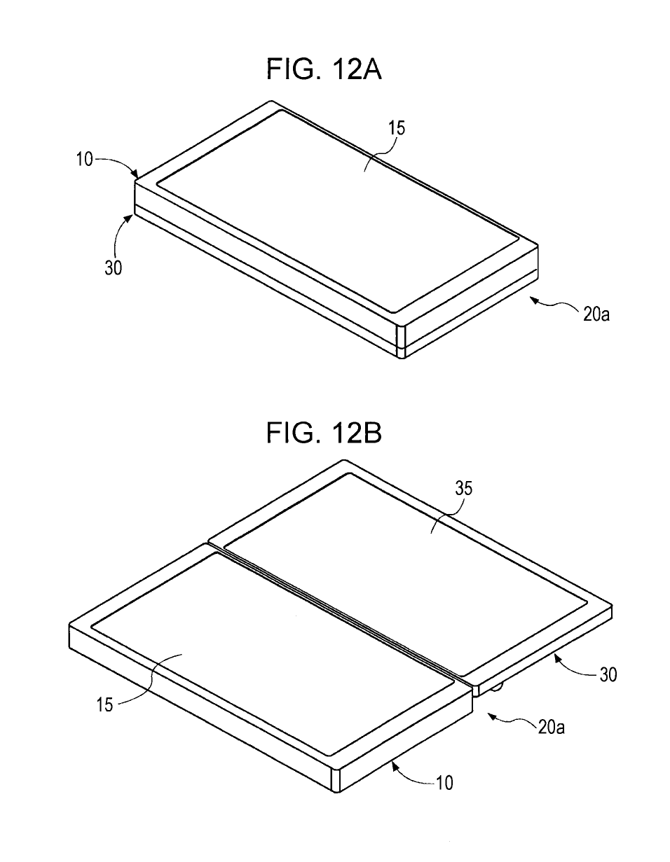

FIGS. 12A and 12B are perspective views of a mobile terminal in a second embodiment in the closed state and open state, respectively. The first case 10 and second case 30 in the second embodiment are identical to those illustrated in FIGS. 1A and 1B, but the hinge part 20 has been replaced with the hinge part 20a.

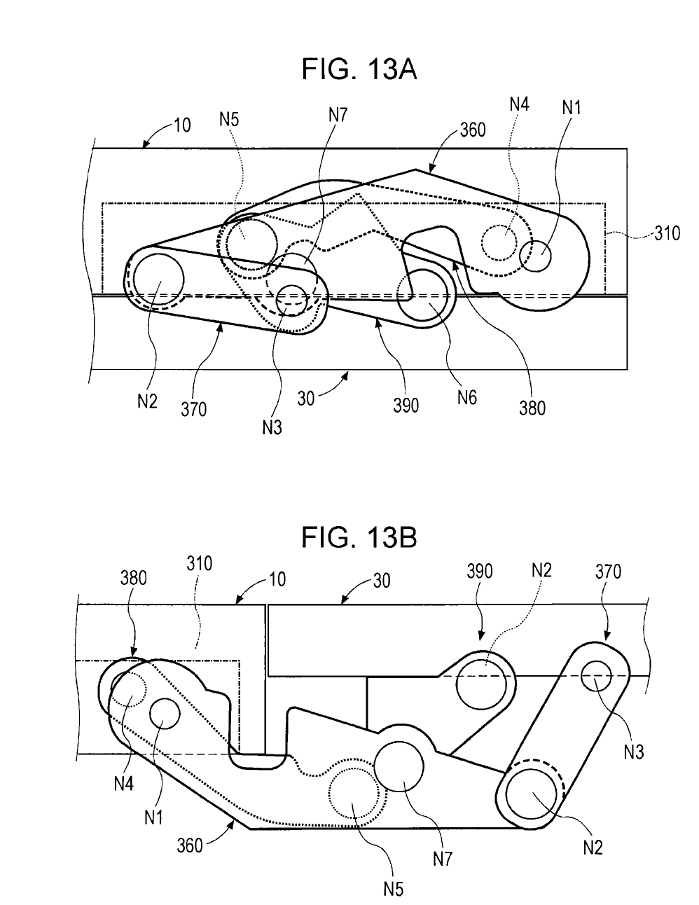

FIGS. 13A and 13B are side views of the hinge part 20a in the closed state and open state, respectively.

The hinge part 20a includes link mechanisms, each of which is formed with four arm members (link members). The arm member will also be referred to below as the arm. Each link mechanism includes a first arm 360, a second arm 370, a third arm 380, and a fourth arm 390. One link mechanism is provided at each of the two sides of the cases 10 and 30. A plurality of arm members constituting one link mechanism are functionally classified into a first arm assembly and a second arm assembly. The first arm assembly, which generates a torque used to open and close the case, includes the first arm 360 and second arm 370. The second arm assembly, which performs positioning in the open state, includes the third arm 380 and fourth arm 390. In the present disclosure, however, it is not essential to share functions between arm assemblies in this way.

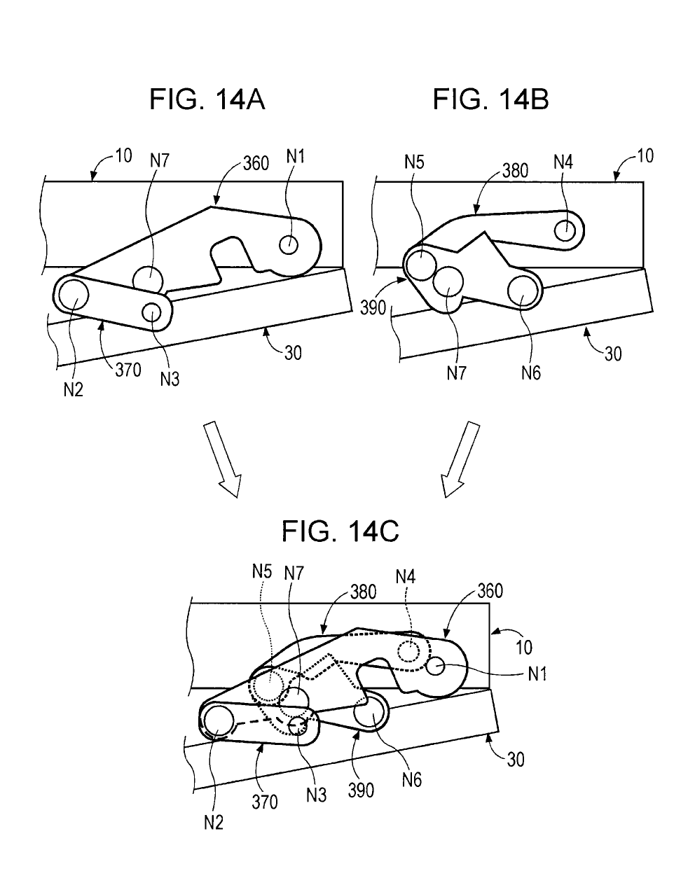

To simplify the description, FIGS. 14A and 14B respectively illustrate the first arm assembly and second arm assembly separately, and FIG. 14C illustrates a state in which the two arm assemblies are combined. In the illustrated state of the second case 30, it is open at a slight angle from the closed state.

As illustrated in FIG. 14A, one end of the first arm 360 included in the first arm assembly is rotatably supported at node N1 of the first case 10, and the other end is rotatably linked to one end of the second arm 370 at node N2. The other end of the second arm 370 is rotatably supported at node N3 of the second case 30. In this example, a cartridge hinge is attached as the driving source that generates a driving force with which the node N1 is rotated.

As illustrated in FIG. 14B, one end of the third arm 380 included in the second arm assembly is rotatably supported at node N4 adjacent to node N1 of the first case 10, and the other end is rotatably linked to the fourth arm 390 at node N5. The other end of the fourth arm 390 is rotatably supported at node N6 of the second case 30.

As illustrated in FIG. 14C, the first arm 360 of the first arm assembly and the fourth arm 390 of the second arm assembly are rotatably linked to each other at node N7 common to the two arm assemblies. The function of node N7 is to reduce the number of degrees of freedom of the link mechanisms of the first arm assembly and second arm assembly and achieve a desired hinge operation as a total of one link mechanism.

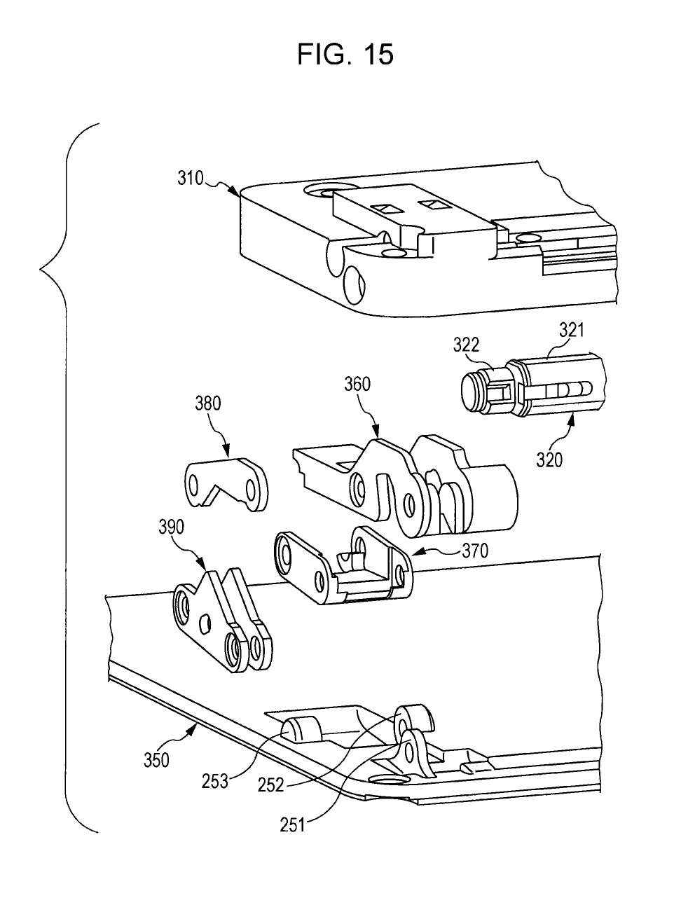

FIG. 15 is a perspective view of specific constituent components of the hinge part 20a in the second embodiment.

Although FIGS. 13 and 14 have illustrated only the side surface shape of each constituent component, FIG. 15 illustrates an example of a stereoscopic structure. Although not shown in FIGS. 13 and 14, the hinge part 20a includes a first base 310 and a second base 350, as in the first embodiment, between which the link mechanisms are disposed. The first base 310 is secured to the first case 10, and the second base 350 is secured to the second case 30. Accordingly, each link mechanism is connected to the first case 10 with the first base 310 interposed therebetween and is connected to the second case 30 with the second base 350 interposed therebetween. One end of the first arm 360 is joined to the rotating part 322 of a cartridge hinge 320, and the main body 321 of the cartridge hinge 320 is secured to the first base 310. The cartridge hinge 320 is identical to the cartridge hinge 220 described above. One end of the third arm 380 is supported by a bearing (invisible in FIG. 15 because it is hidden) of the first base 310. The other end of the second arm 370 is supported by bearings 252 and 253 by using pins (not shown). The other end of the fourth arm 390 is supported by a bearing 251 through a pin (not shown).

Although FIG. 15 illustrates the structure on only one side, symmetrical structures can be basically used on the two sides. If the driving force of the cartridge hinge 320 at one side is sufficient, however, a structure in which a driving source may be provided on only one side.

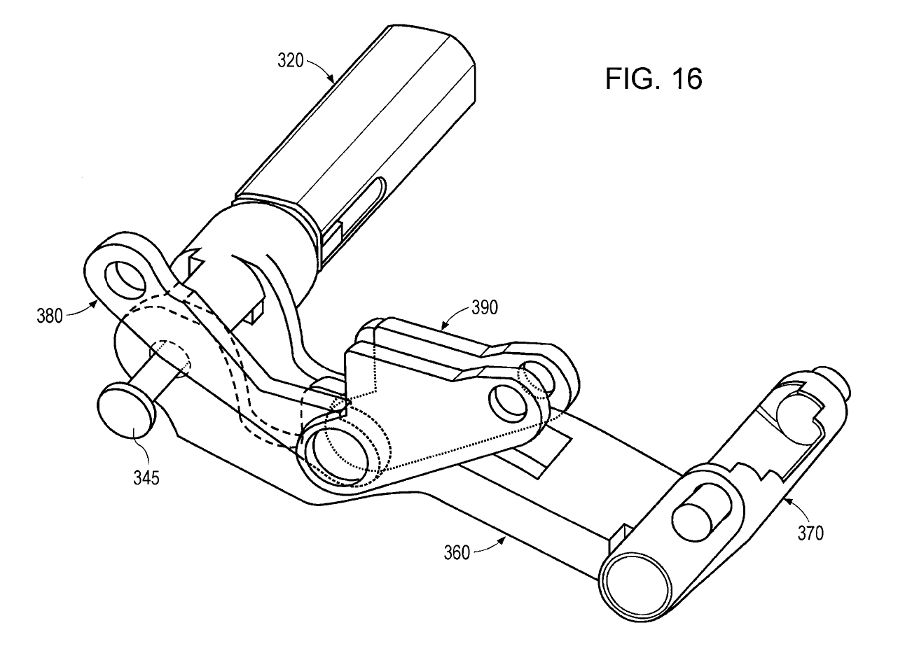

FIG. 16 is a perspective view of the hinge part 20a formed by assembling the constituent components illustrated in FIG. 15 (excluding the first and second bases 310 and 350). In the example in the drawing, the open state is illustrated.

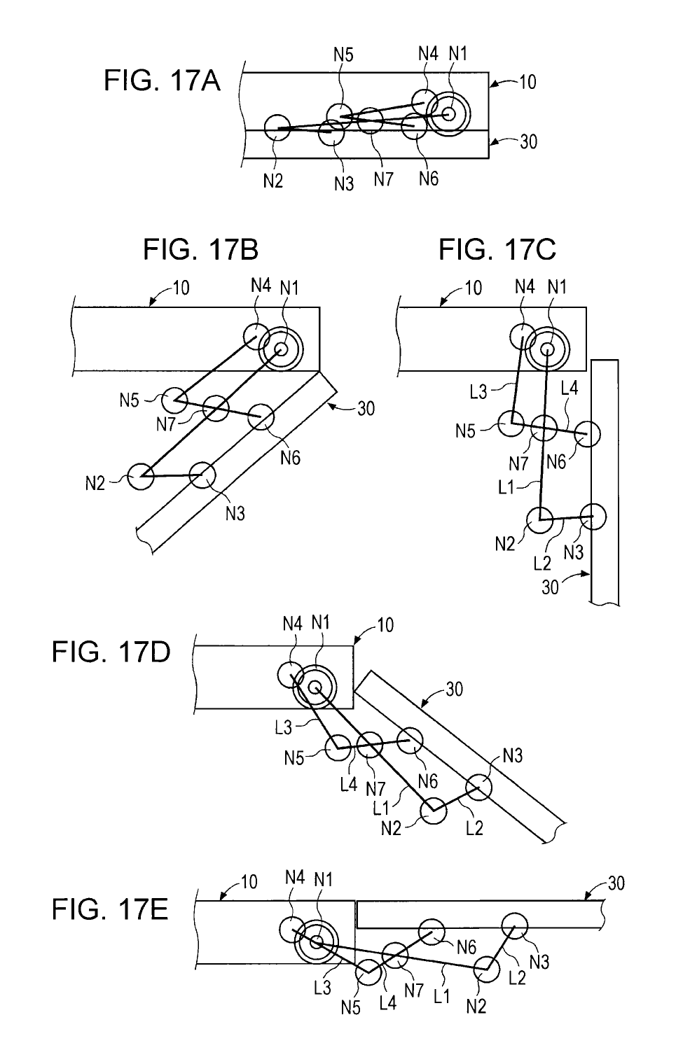

FIGS. 17A to 17E illustrate the states of the link mechanism of the hinge part 20a, starting from the closed state of the mobile terminal in the second embodiment and continuing until the mobile terminal reaches the open state through a transient state. A circle in the drawing indicates a node. A node that doubles as a driving source (node N1 in this example) is indicated by a large triple circle. The first arm 360, second arm 370, third arm 380, and fourth arm 390 correspond to links L1, L2, L3, and L4, respectively.

When the second case 30 is opened by the link mechanism having this structure with respect to the first case 10 from the closed state in FIG. 17A, the second case 30 rotates as illustrated in FIGS. 17B to 17D, without interfering with the first case 10. In the open state illustrated in FIG. 17E, indicating the end point of the rotation, the first case 10 and second case 30 are opened 180 degrees; the two display screens are placed side by side on the same plane. There is no clearance between the cases 10 and 30.

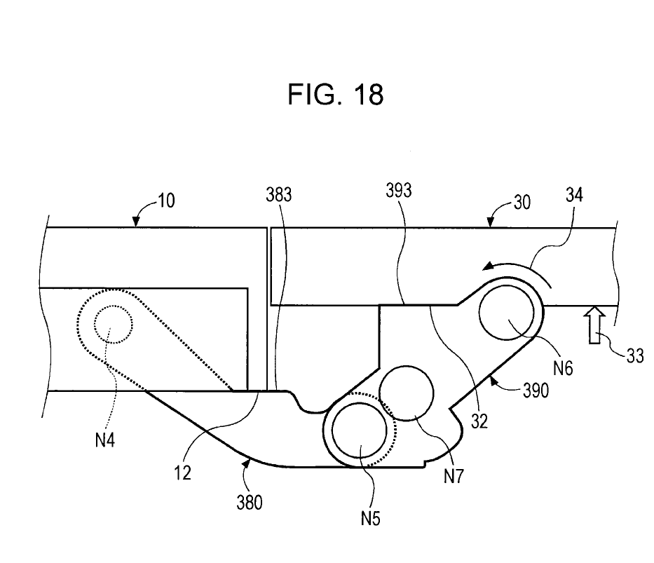

The effect of the second arm assembly in the open state will be described with reference to FIG. 18. For convenience, the first arm assembly is not shown. In this case, a force is exerted on the second case 30 from the driving source through the first arm assembly, as indicated by the arrow 33, the force pushing the second case 30 from the bottom. As for positioning in the open state, since part 383 of a side surface of the third arm 380 abuts the edge 12 of the first case 10, further rotation of the third arm 380 is prevented. This prevents the entire link mechanism from further rotating. An inclined side surface 393, which protrudes in a triangular shape, of the fourth arm 390 abuts the rear surface 32 of the second case 30. This prevents the second case 30 from further rotating around node N6 of the fourth arm 390 in the direction indicated by the arrow 34.

In the structure illustrated in FIG. 18, there is a rotation stopper on a circumference with a relatively large diameter around the rotational axis. When a stopper is provided on a circumference with a relatively large diameter in this way, error in the rotational angle of the second case 30 with respect to the first case 10 in the open state is lessened. Furthermore, when the lengths of the link members of each link mechanism and the position of each node are appropriately set, the clearance between the two cases is eliminated. The structure of the hinge part 20a in the second embodiment eliminates the need to use the springs 249 in the first embodiment) other than the driving sources that generate a rotational driving force.

Next, a third embodiment of the present disclosure will be described.

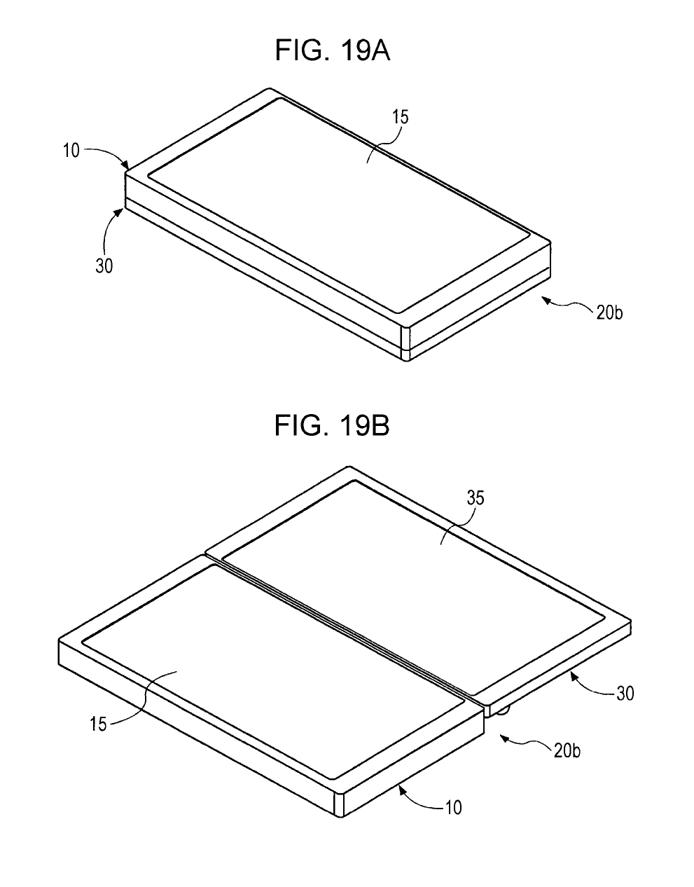

FIGS. 19A and 19B are perspective views of a mobile terminal in a third embodiment of the present disclosure in the closed state and open state, respectively. The first case 10 and second case 30 in the third embodiment are identical to those illustrated in FIGS. 2A and 2B, but the hinge part 20a has been replaced with a hinge part 20b. Although, in the third embodiment, a link mechanism similar to the link mechanism in the second embodiment is used, the size of the hinge part is reduced. Therefore, the number of driving sources in one link mechanism is increased to two. In this embodiment, driving sources are provided separately at the root axial parts to the bases of the two arms of the second arm assembly.

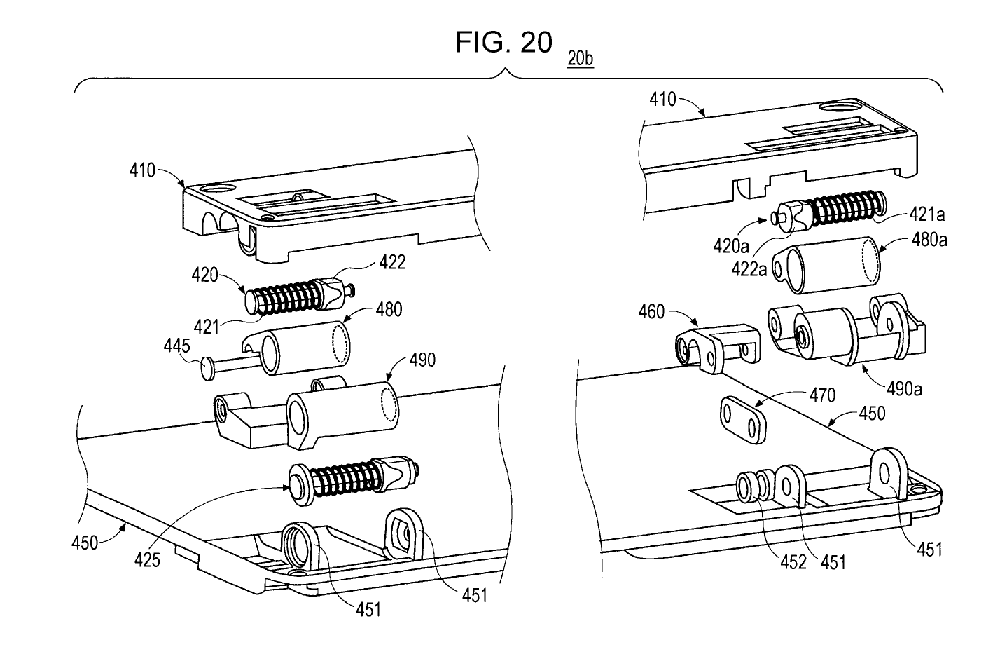

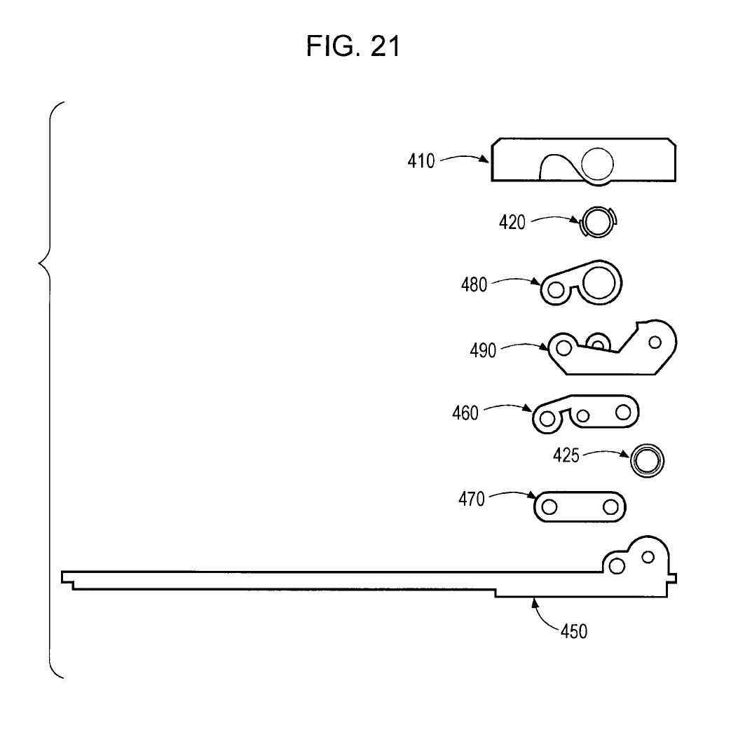

FIG. 20 is an exploded perspective view of the hinge part 20b in the third embodiment of the present disclosure. FIG. 21 is a side view of a plurality of constituent components of the hinge part 20b in FIG. 20.

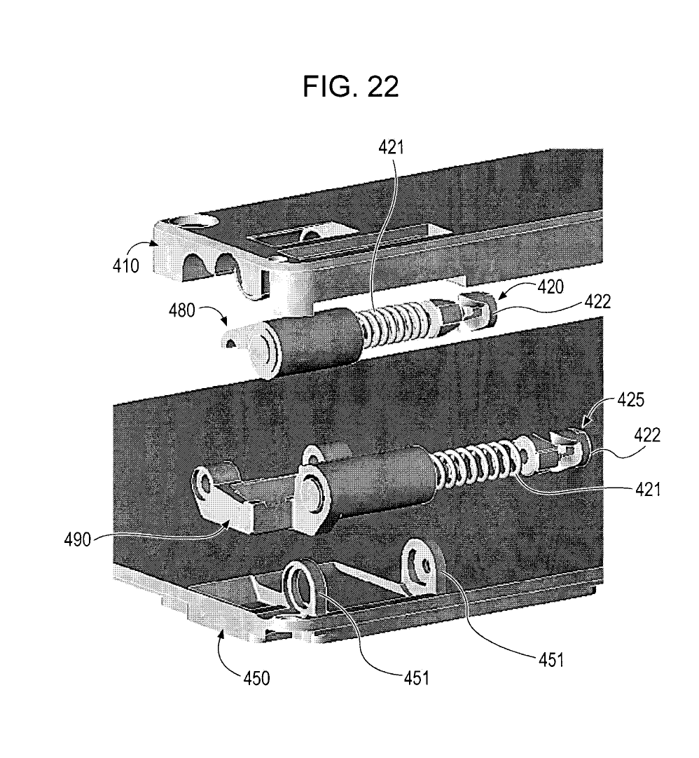

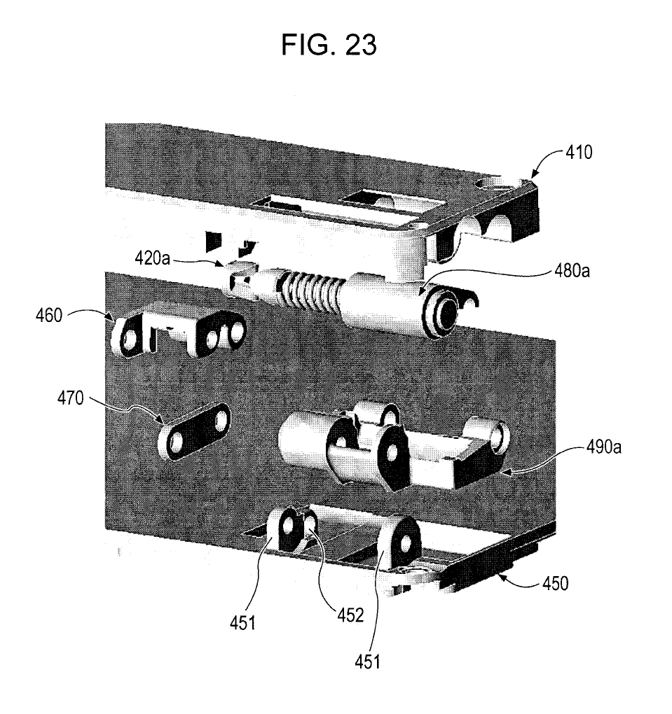

As illustrated in FIG. 20, one link mechanism is provided at each of the two sides in the hinge's axial direction between a first base 410 secured to the first case 10 and a second base 450 secured to the second case 30. FIGS. 22 and 23 are enlarged gray-scale stereoscopic views illustrating examples of the structures of the hinge part at the left end and right end in FIG. 20, respectively. As seen from these drawings, some elements of the link mechanism are eliminated on the left end. Of course, identical (bilaterally symmetrical) constituent parts may be provided at the right and left ends without elimination.

One link mechanism is formed with four link members, a first arm 460, a second arm 470, a third arm 480 and a fourth arm 490. The link mechanism formed with these four arms have link members equivalent to the first arm 360, second arm 370, third arm 380, and fourth arm 390 in the second embodiment except their sizes, the number of driving sources, and the positions of the nodes. The second base 450 has bearings 451 and 452 that support the ends of the fourth arm 490 (490a) and second arm 470. A torque generator 420 (420a) has a compression coil spring 421 wound on a shaft and an inverted torque member 422 that generates an inverted torque. The torque generator 420 (420a) is accommodated in a cylindrical part of the third arm 480 (480a); the torque generator 420 (420a) achieves a function similar to the function of the cartridge hinge 320. A torque generator 425 having a structure similar to the structure of the torque generator 420 is accommodated in a cylindrical part of the fourth arm 490; the torque generator 425 achieves a function similar to the function of the cartridge hinge 320.

In this example, a driving source is provided at node N4 of the third arm 480 in the first case 10, and another driving source is also provided at node N6 of the fourth arm 490 in the second case 30. That is, functions of generating a torque with which the second case 30 is opened or closed are shared between the third arm 480 and the fourth arm 490, which constitute the second arm assembly. In this example, a positioning function in the open state is assigned to the second arm assembly, as described later. The first arm 460 and second arm 470 constituting the first arm assembly is provided at only one side (on the right side of the drawing). The function of the first arm assembly is to achieve a desired effect of the link mechanism in cooperation with the second arm assembly.

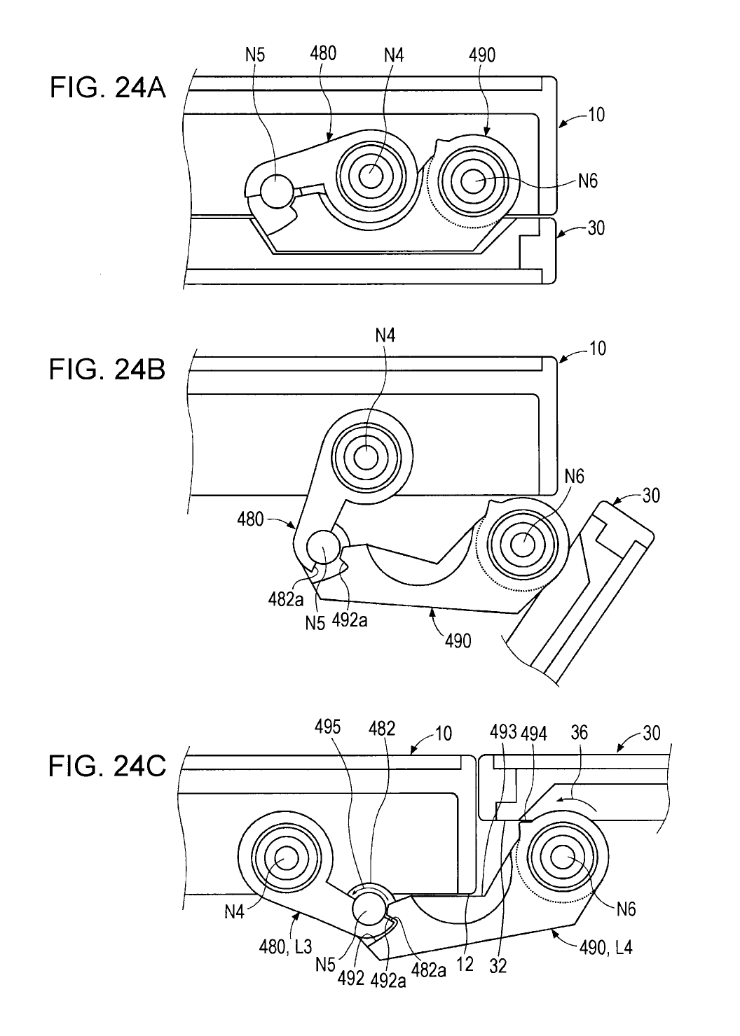

FIGS. 24A to 24C are side views of the third arm 480 and fourth arm 490 (second arm assembly) in the closed state, transient state, and open state in the third embodiment, respectively. For convenience, the first arm assembly is not shown in the drawing. The torque generator 420 is disposed at node N4 of the third arm 480, and the torque generator 425 is disposed at node N6 of the fourth arm 490; these torque generators each function as a driving source.

In the open state illustrated in FIG. 24C, an upright wall 482a of a substantially half-donut shaped notch 482 formed at node N5 of the third arm 480 abuts a stopping part 492a of a notch 492 formed at node N5 of the fourth arm 490. This suppresses further rotation of the third arm 480 at node N5 with respect to the fourth arm 490 in the direction indicated by the arrow 495. When part 493 of a side surface of the fourth arm 490 abuts the edge 12 of the first case 10, further upward rotation of the second arm assembly (third arm 480 and fourth arm 490 in the open state) with respect to the first case 10 is prevented. Furthermore, a surrounding protrusion 494 at node N6 of the fourth arm 490 abuts the rear surface 32 of the second case 30. This prevents further rotation of the second case 30 with respect to the fourth arm 490 in the direction indicated by the arrow 36. Angles to suppress rotation at these three locations in the open state are designed so that the first case 10 and second case 30 are opened 180 degrees, the two display screens are placed side by side on the same plane, and no clearance is left between the first case 10 and the second case 30, as illustrated in FIG. 24C.

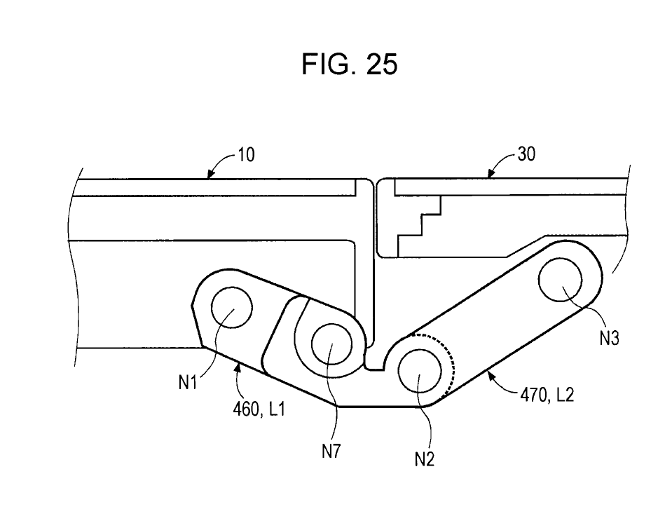

FIG. 25 is a side view of the first arm 460 and second arm 470 (first arm assembly) in the open state in the third embodiment. For convenience, the second arm assembly is omitted in this drawing. As in the second embodiment, the first arm 460 is linked to the third arm 480 at node N7 common to the two arms so as to be mutually rotatable.

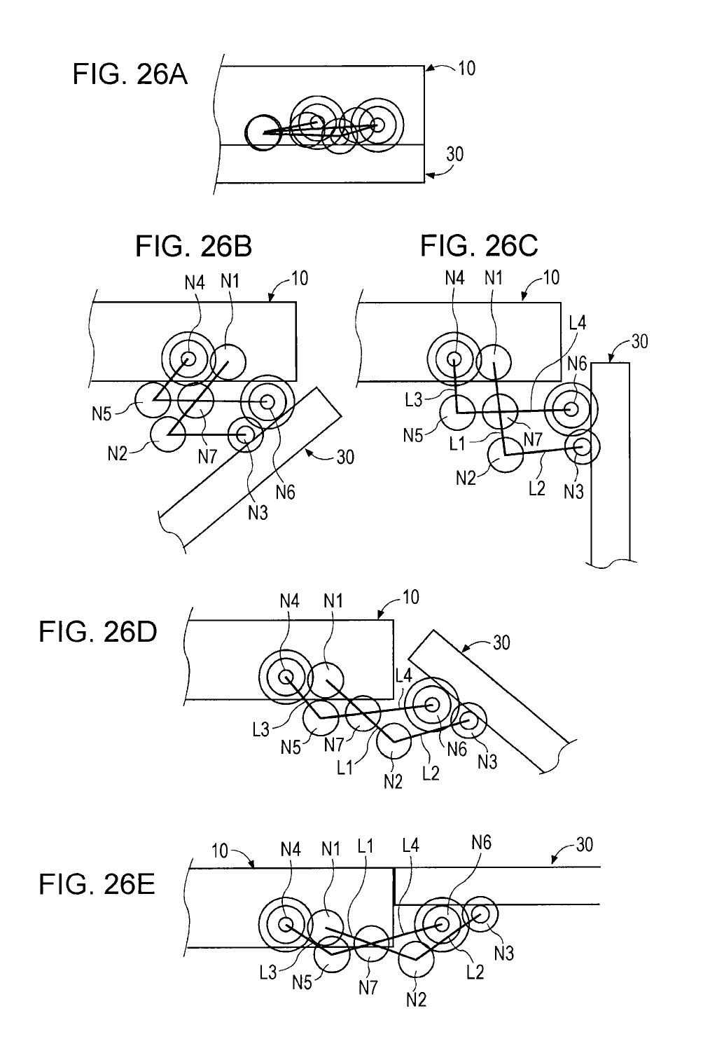

FIGS. 26A to 26E illustrate the states of the link mechanism of the hinge part 20b, starting from the closed state of the mobile terminal in the third embodiment and continuing until the mobile terminal reaches the open state through a transient state. A circle in the drawing indicates a node. Nodes N4 and N6 that double as a driving source are indicated by large triple circles.

When the second case 30 is opened by the link mechanism having this structure with respect to the first case 10 from the closed state in FIG. 26A, the second case 30 rotates as illustrated in FIGS. 26B to 26D, without interfering with the first case 10. In the closed state illustrated in FIG. 26E, indicating the end point of the rotation, the first case 10 and second case 30 are opened 180 degrees; the two display screens are placed side by side on the same plane. There is no clearance between the two cases 10 and 30.

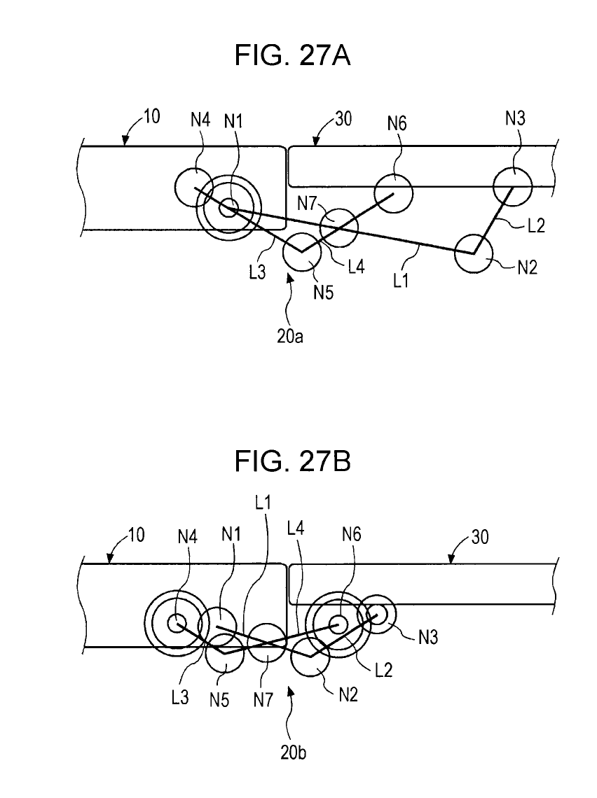

Effects and advantages in the second embodiment and third embodiment will be compared with reference to FIGS. 27A and 27B. FIG. 27A illustrates the link mechanism with the hinge part 20a in the open state, and FIG. 27B illustrates the link mechanism with the hinge part 20b in the open state; these link mechanisms are scaled to the same ratio with respect to their actual sizes. As seen from the two drawings, each link member of the hinge part 20b is shorter than its corresponding link member of the hinge part 20a. If the link member of the hinge part 20a is simply shortened, the load applied to the single driving source at node N1 becomes large. This may make it difficult to smoothly rotate the two cases and stably maintain the open state and closed state. With the hinge part 20b, however, since a plurality of driving sources are included in the link mechanism, this problem is solved.

Although, in this example, the first and second driving sources have been included at nodes (N4 and N6) of a single arm assembly (second arm assembly), they may be included at nodes (N1 and N3, for example) of different arm assemblies.

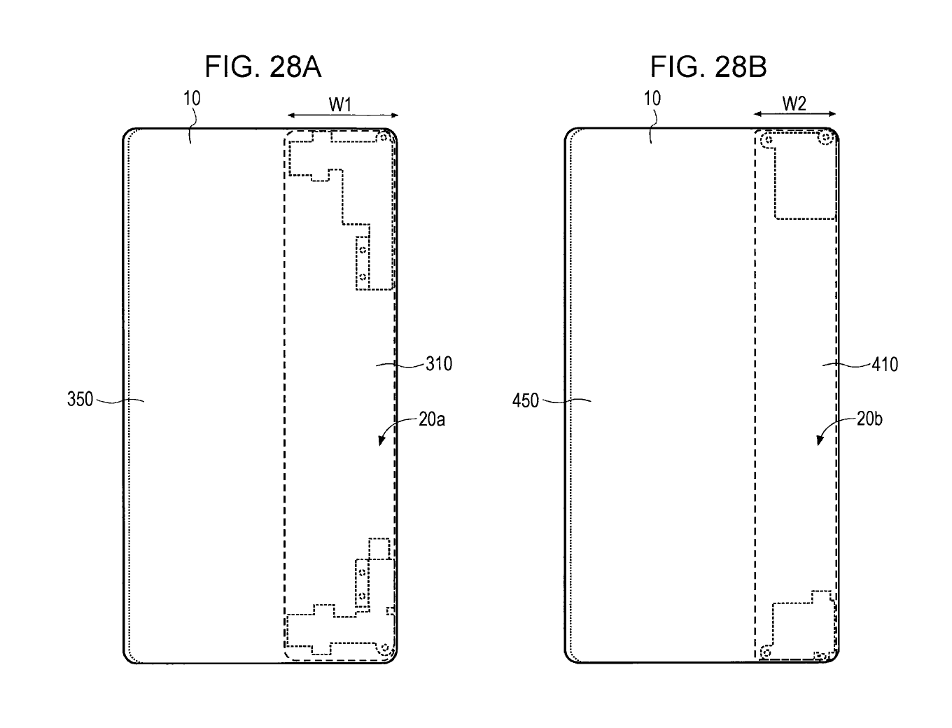

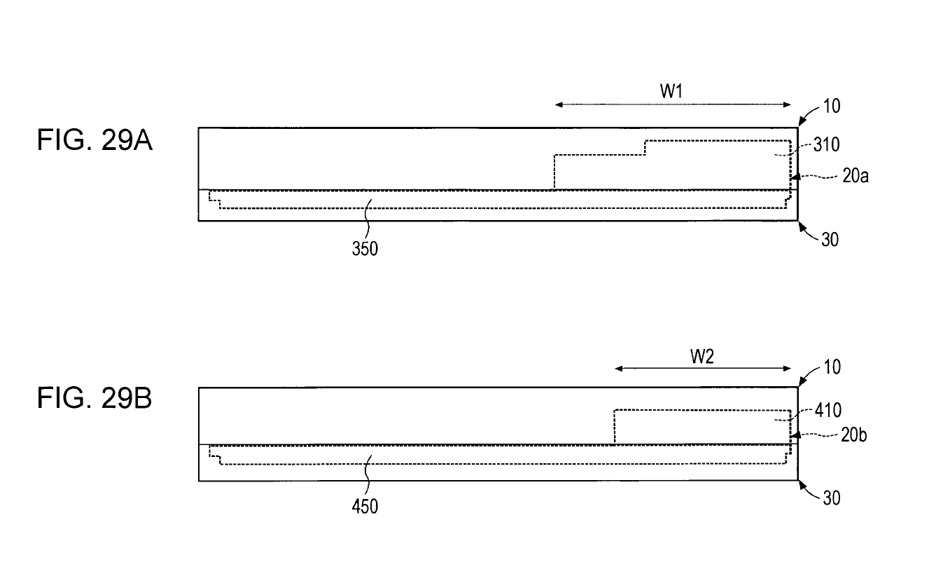

FIGS. 28A and 28B compare the sizes of the hinges 20a and 20b of the mobile terminals in the second embodiment and third embodiment in the closed state, as viewed from above. FIGS. 29A and 29B compare the sizes of the hinges 20a and 20b of the mobile terminals in the second embodiment and third embodiment in the closed state, as viewed from a side surface, particularly indicating that the width W2 of the first base 410 in the third embodiment is reduced as compared with the width W1 of the first base 310 in the second embodiment. This reduction in hinge part size contributes to the compactness of the mobile terminal and the reduction of its weight.

As a feature common to the first, second, and third embodiment, it has been described that when a side surface of the arm member partially abuts part of the first case in the open state, further rotation of the arm member is prevented. As seen from the above description, however, each embodiment has its specific features in addition to the feature that prevents the arm member from further rotating.

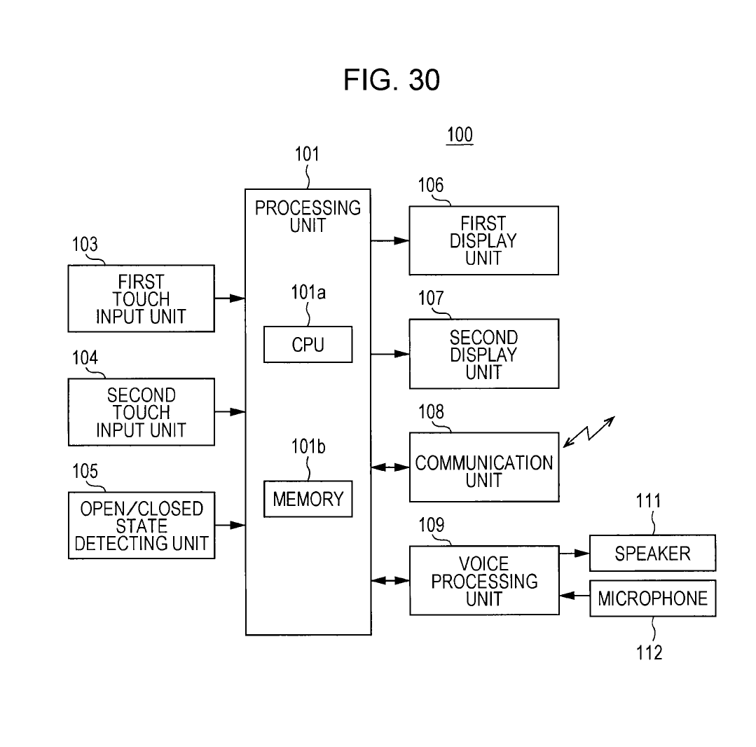

Next, a block diagram representing an exemplary structure of the control hardware of a mobile terminal 100 is shown in FIG. 30.

The mobile terminal 100 includes a processing unit 101, a first touch input unit 103, a second touch input unit 104, an open/closed state detecting unit 105, a first display unit 106, a second display unit 107, a communication unit 108, a voice processing unit 109, a speaker 111, a microphone 112, and the like.

The processing unit 101 is a unit that performs various types of control and processing in the mobile terminal 100. The processing unit 101 includes a CPU 101a, a memory 101b, and the like. The processing unit 101 also functions as a control unit that performs specific control related to a display function and touch detection function in this embodiment.

The first touch input unit 103 is a unit that provides a touch input area overlaid on the display area of the first display screen 15. The second touch input unit 104 is a unit that provides a touch input area overlaid on the display area of the second display screen 35. These touch input units are not restricted to a particular method of detecting a touch.

The open/closed state detecting unit 105 is a unit that detects at least one of the open state and closed state of the mobile terminal 100. The open/closed state detecting unit 105 is not restricted to a particular detection method. For example, a magnetic sensor, an optical sensor, a mechanical sensor, or a unit using any other method can be employed.

The first display unit 106 is formed with a display device having the first display screen 15 mounted on the first case 10. The second display unit 107 is formed with a display device having the second display screen 35 mounted on the second case 30. There is no particular restriction on the type of display device; for example, a liquid crystal display device, an organic EL device, and another flat display device may be used.

The communication unit 108 is a unit that carries out wireless communication to makes a call for the mobile terminal (mobile telephone terminal) and for data communication. The communication unit 108 may have a keypad, implemented by hardware keys, which receives user's inputs. In addition, the communication unit 108 may have a near field communication unit such as for a wireless LAN or Bluetooth®.

The voice processing unit 109 includes a codec, which codes and decodes voice signals, and other devices. The voice processing unit 109 is connected to the speaker 111, which outputs voice, and the microphone 112, which receives voice.

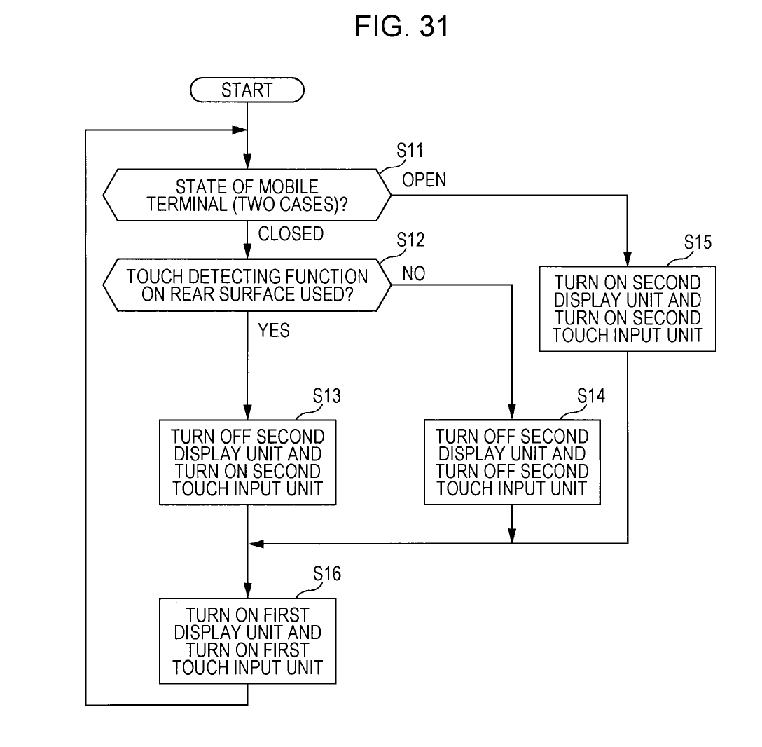

FIG. 31 illustrates exemplary processing, executed by the processing unit 101, that can be used for the mobile terminals in the embodiments described above. This processing is achieved by having the CPU 101a execute a program stored in the memory 101b. However, this processing is not essential to the present disclosure.

This processing is initiated by turning on power to the mobile terminal. First, the processing unit 101 checks the current state of the mobile terminal, that is, whether the mobile terminal is in the open state or closed state, according to the output from the open/closed state detecting unit 105 (S11). If the current state is the closed state, the processing unit 101 checks whether to use the touch detection function on the rear surface, that is, the second touch input unit 104 (S12). This check can be carried out according to, for example, the initial settings, the application being executed, the current operation mode, or the like.

When the touch detecting function is used, the processing unit 101 disables (turns off) the second display unit 107 and enables (turns on) the second touch input unit 104 (S13). Then, the processing unit 101 turns on the first display unit 106 and turns on the first touch input unit 103 (S16). Then, the processing unit 101 returns to step S11.

If the processing unit 101 confirms in step S12 above that the touch detection function on the rear surface is not sued, the processing unit 101 turns off the second display unit 107 and turns off the second touch input unit 104 (S14). Then, the processing unit 101 proceeds to step S16.

If the mobile terminal is in the open state in step Sll above, the processing unit 101 turns on the second display unit 107 and turns on the second touch input unit 104 (S15). Then, the processing unit 101 proceeds to step S16.

As described above, unnecessary loads and power consumption can be reduced by turning off the display unit and touch input unit that will not be used.

Although preferred embodiments of the present disclosure have been described, various variations and modifications can be made besides the above descriptions. That is, it will be understood by those skilled in the art that various modification and combinations and other embodiments may be derived from design or other elements within the range of the claims or an equivalent range of the claims.

For example, as suggested in each embodiment, identical link mechanisms may be provided on both sides of the case along its edges, one on each side, or one link mechanism may be provided on only one side. Alternatively, only some parts may be provided on both sides. Although the sizes of the first case and second case projected on the plane on which they are placed have been substantially the same, their sizes are not necessarily the same.

1. An information processing apparatus comprising:
a first case including a first display unit having a first display screen;
a second case including a second display unit having a second display screen;
a hinge configured to rotatably link the first and second cases so that both of the first and second display screens are exposed to an outside in a closed state and both the first and second display screens are adjacently placed on substantially same plane in an open state;
a detector configured to detect whether the first and second cases are in the open state or the closed state; and
circuitry configured to:
enable a display function of both the first and second display units when an output of the detector indicates that the first and second cases are in the open state; and
enable the display function of the first display unit and disable the display function of the second display unit when the output of the detector indicates that the first and second cases are in the closed state.

2. The information processing apparatus of claim 1, wherein
the first and second display units are configured to detect a touch input received at the respective first and second display screens.

3. The information processing apparatus of claim 2, wherein
the circuitry is configured to:
enable the display function and a touch detection function of both the first and second display units when an output of the detector indicates that the first and second cases are in the open state; and
enable the touch detection function of both the first and second display units, enable the display function of the first display unit, and disable the display function of the second display unit when the output of the detector indicates that the first and second cases are in the closed state.

4. The information processing apparatus of claim 1, wherein
the hinge part includes a rotating part disposed inside one end of the first case and an arm member that protrudes from the rotating part to an outside of the first case and is linked to the second case.

5. The information processing apparatus of claim 4, wherein
rotation of the arm member is prevented when a side surface of the arm member partially abuts part of the first case in the open state.

6. The information processing apparatus of claim 4, wherein
the hinge part includes a cam mechanism configured to hold the second case so as to be movable in a prescribed area relative to the arm member.

7. The information processing apparatus of claim 6, wherein
the hinge part includes an elastic member configured to draw the second case toward the rotating part in the first case.

8. The information processing apparatus of claim 7, wherein
during a shift from the closed state to the open state, a total amount of rotation of the second case with respect to the first case includes, in addition to the maximum amount of rotation of the arm member, a prescribed amount of rotation added by the cam mechanism.

9. The information processing apparatus of claim 7, wherein
the second case is configured to shift to be apart from the rotating part of the hinge part against an elastic force of the elastic member, and the cam mechanism functions to rotate the second case by the prescribed amount of rotation with respect to the arm member when the second case shifts from the closed state to the open state with respect to the first case.

10. The information processing apparatus of claim 1, wherein
the hinge part includes a first arm member, one end of which is connected to rotating part disposed inside one end of the first case.

11. The information processing apparatus of claim 10, wherein
the hinge part includes a second arm member, one end of which is rotatably connected to another end of the first arm member and another end of which is rotatably connected to a first place of the second case.

12. The information processing apparatus of claim 11, wherein
the hinge part includes a third arm member, one end of which is rotatably connected to a place other than the rotating part of the first case.

13. The information processing apparatus of claim 12, wherein
the hinge part includes a fourth arm member rotatably connected to another end of the third arm member, another end of the fourth arm member being rotatably connected to a second place of the second case.

14. The information processing apparatus of claim 13, wherein
the first arm member and the fourth arm member are rotatably connected.

15. The information processing apparatus of claim 1, wherein
the hinge part includes a driving source configured to generate a driving force with which both the open state and the closed state are maintained so that the open state is maintained when the first and second cases are in the open state and the closed state is maintained when the first and second cases are in the closed state.

16. The information processing apparatus of claim 14, wherein
the hinge part includes a first driving source, at one end of the third arm member or first arm member connected to the first case, that generates a driving force with which both the open state and the closed state are maintained so that the open state is maintained when the first and second cases are in the open state and the closed state is maintained when the first and second cases are in the closed state.

17. The information processing apparatus of claim 16, wherein
the hinge part includes a second driving source, at one end of the fourth arm member or second arm member connected to the second case, that generates a driving force with which both the open state and the closed state are maintained so that the open state is maintained when the first and second cases are in the open state and the closed state is maintained when the first and second cases are in the closed state.

18. A method performed by an information processing apparatus, the method comprising:
detecting whether a first case and a second case are in an open state or a closed state, wherein the first case includes a first display unit having a first display screen, the second case includes a second display unit having a second display screen, and the first and second cases are rotatably linked by a hinge so that both of the first and second display screens are exposed to an outside in the closed state and both the first and second display screens are adjacently placed on substantially same plane in the open state;
enabling a display function of both the first and second display units when a result of the detection indicates that the first and second cases are in the open state; and
enabling the display function of the first display unit, and disabling the display function of the second display unit when the result of the detection indicates that the first and second cases are in the closed state.

19. A non-transitory computer-readable medium including computer-program instructions, which when executed by an information processing apparatus, cause the information processing apparatus to:
detect whether a first case and a second case are in an open state or a closed state, wherein the first case includes a first display unit having a first display screen, the second case includes a second display unit having a second display screen, and the first and second cases are rotatably linked by a hinge so that both of the first and second display screens are exposed to an outside in the closed state and both the first and second display screens are adjacently placed on substantially same plane in the open state;
enable a display function of both the first and second display units when a result of the detection indicates that the first and second cases are in the open state; and
enable the display function of the first display unit, and disable the display function of the second display unit when the result of the detection indicates that the first and second cases are in the closed state.
